(19) United States
(12) Patent Application Publication
(10) Pub. No.: US 2016/0249596 A1
(43) Pub. Date: Sep. 1, 2016

(54) FLIP-FLOP GLUED-ON HORSE SHOE

(71) Applicant: GARRETT N. FORD, DURANGO, CO (US)

(72) Inventor: GARRETT N. FORD, DURANGO, CO (US)

(21) Appl. No.: 15/046,470

(22) Filed: Feb. 18, 2016

Related U.S. Application Data
(60) Provisional application No. 62/126,391, filed on Feb. 27, 2015.

(51) Int. Cl. A01L 3/02

(52) U.S. Cl. CPC A01L 3/02

(57) ABSTRACT

A glued-on horse shoe consists of a sole and an upper with two side walls separated by a front slit and attached to an outer periphery of the sole. The shoe is attached to the horse's hoof without placing any glue between the heel and the sole. The side walls extend backward from the front side of the hoof only at most to a midsection of the hoof and are folded inward to butt against the hoof. Bonding material is preferably placed only between the hoof of the horse and the interior surfaces of the upper for adhering the shoe to the hoof, so that the sole remains unattached to the bottom surface of the hoof and free to move in flip-flop fashion in relation to the hoof. The middle of the sole may include an opening.

### RELATED APPLICATIONS

This application is based on and claims the priority of provisional application Serial No. 62/126,391 filed Feb. 27, 2015, hereby incorporated by reference.

### BACKGROUND OF THE INVENTION

1. Field of the Invention

The invention relates in general to boots for horses and, in particular, to a boot held in place only by bonding the interior surface of the boot to the hoof of the horse.

2. Description of the Prior Art

Horse boots are used to protect the hooves and fetlocks of horses and it has become common place to use them in lieu of horseshoes. A horse boot typically includes a sole with opposed flat, top and bottom, major surfaces that cover the underside of the hoof and an upper that projects upward from the top surface of the sole and forms an enclosure for at least a portion of the hoof of the horse. The upper typically extends along the rim of the sole and has a bottom edge secured to the sole. A tongue is often formed in the front portion of the upper and the top edge of the upper is remote from the sole and is sometime connected to a cuff that can be tightened around the pastern of the horse.

In the typical arrangement, the upper and the cuff (if present) are spread open in order to place the boot on the hoof of the horse. After spreading open the upper and the cuff, the boot is slid over the hoof and the upper is tightened by some means around the hoof to secure the boot in place. Several means for tightening the upper have been used in the art, such as laces, flexible straps, elastic straps, and cables connected to a buckle or other tensioning device mounted on the boot. As the buckle is pivoted closed, it pulls on the cable and tightens both front ends of the upper around the hoof.

Such tensioning devices have been improved and perfected over the years to provide variable degrees of tensioning and ranges of adjustment to fit different riding conditions and hoof sizes. However, fitting a boot to a particular hoof remains a challenge because of the variation in the size and shape of horses' hooves. Even among horses wearing the same size boot (which is determined by the size of the footprint of the hoof), the shape and slope of the hoof's top portion vary from horse to horse, requiring different degrees of tension in order to cause the upper to adhere to the hoof's sides and firmly secure the boot on the hoof. Furthermore, tensioning devices are subjected to severe mechanical stresses during use, especially during hard riding conditions, and therefore they tend to break. When that happens, the only recourse is a replacement boot, which may or may not be available while riding out in the field.

Co-owned U.S. Ser. No. 12/401,107, now abandoned, describes a horse boot secured to the hoof of the horse only by bonding, without any additional restraining device. The boot is designed for a rapid and durable fit, and for maximum flexibility in conforming to the shape of the hoof. The upper includes substantially independent side walls that can be flexed as needed to conform to the shape of the hoof to which the boot is fitted. Prior to fitting, the inside of the boot is lined with bonding material along the interior surface of the upper. The boot is then fitted to the hoof by sliding it into place until the hoof butts firmly against the front of the upper. Because of the shape and flexibility of the upper, the boot conforms readily to the side surface of the hoof and stays in place while the bonding material is hardening, even without pressing the upper against the hoof. The entire fitting process may be carried out in less than two minutes. However, in part because of the longevity of the attachment, it has been found that moisture and debris eventually enters from the back of the boot and accumulates in the enclosed space between the sole of the boot and the frog of the hoof, which tends to produce undesirable sanitary conditions.

U.S. Pat. No. 4,892,150 (Thoman) describes another glued-on boot. A polymeric horseshoe is attached to a shoe structure with upward extending tabs that are bonded to the hoof. However, extended tests on a similar boot (i.e., a glued-on boot with an open bottom and a polymeric horseshoe integral with an upper that conforms to the hoof) demonstrated that the boot quickly begins to show signs of loosening from the rear portion of the hoof and eventually it becomes totally separated. It appears that the deformation of the hoof caused by the enlargement of the frog at each step produces a strain on its bond with the boot. As the hoof increases in size (in width) on impact with the ground, the horseshoe portion of the boot, having an open back side at the heel, is forced to increase its width against its normal shape and the resulting strain eventually produces a breakdown in the bond and the detachment of the boot. Numerous attempts to correct this problem with different placements of the glue and with different retaining structures in the heel were not successful.

U.S. Ser. No. 14/184,675 describes a glued-on horse boot with an upper that includes substantially independent side walls that may be flexed inward or outward as needed to conform to the shape of the hoof to which the boot is fitted. The upper has no front portion and is preferably integral with an open sole consisting of a polymeric horseshoe with free heel ends defining a gap. A cantilevered resilient frog support connects the heel ends of the horseshoe, thus providing a spring-like structure tying the heel ends together. The interior surface of the horseshoe has a grid of interconnected recesses and the upper has lateral perforations adapted to receive glue material. The boot is fitted to the hoof by lining the surfaces of the upper and the horseshoe with glue and holding the boot in place while the glue hardens, thereby securing the boot to the hoof.

Copending U.S. Ser. No. 14/165,646 describes another horse shoe has an upper with independent side walls that conform to the shape of the hoof. The upper includes a toe clip, two side tabs in the front half and two side walls in the rear half of the shoe, preferably all integral with a polymeric horseshoe with heel portions defining a gap. A cantilevered resilient bridge connects the heel portions, thus providing a spring-like structure tying the heel portions together. The top surface of the horseshoe has a grid of interconnected recesses and the upper has lateral perforations adapted to receive glue material. The shoe is fitted to the hoof by lining the surfaces of the upper and the horseshoe with glue and holding the shoe in place while the glue hardens, thereby securing the shoe to the hoof.

Alternatively, the shoe is nailed on the hoof like a conventional horseshoe after removal of the side walls.

While each of the above described glued-on boots and shoes represents an improvement in the art, they all still suffer from a common problem that has been shown to limit their otherwise very extended life. They all tend to eventually separate at the heel of the shoe. Once that happens, the shoe has to be either refitted or removed. The cause had been believed to be the movement of the heel in relation to the shoe while the horse walks or gallops. Therefore, all glued-on shoes have relied on a secure connection at the heel of the shoe. However, the heel of the horse has the greatest amount of horizontal expansion and contraction, in addition to the heel's sides independent vertical movements. While these vertical and horizontal motions are key to the health of the hoof, they also compromise the adhesive bond with the shoe at the heel and with time the connection starts to fail at the very tip of the heel. The failure slowly moves forward after a break occurs at the heel area. The present invention provides an unexpected solution to this problem.

### SUMMARY OF THE INVENTION

The invention lies in the unconventional idea of attaching a glued-on horse shoe on a horse's hoof without placing any glue between the hoof and the sole of the shoe. The shoe consists of a sole and an upper with two side walls separated by a front slit and attached to an outer periphery of the sole. The side walls extend backward from the front side of the hoof only to a midsection of the hoof and are folded inward to butt against the hoof. In the preferred embodiment, bonding material is placed substantially only between the hoof of the horse and the interior surfaces of the upper for adhering the shoe to the hoof of the horse, so that the sole remains substantially unattached to the bottom surface of the hoof and free to move in flip-flop fashion in relation to the hoof. The middle of the sole may include an opening.

Additional features and advantages of the invention will be forthcoming from the following detailed description of certain specific embodiments when read in conjunction with the accompanying drawings.

### BRIEF DESCRIPTION OF THE DRAWINGS

FIG. 1 is a perspective view of the back left side of a horse shoe according to the invention.

FIG. 2 is a perspective view of the front-left side of the horse shoe of FIG. 1.

FIG. 3 is a perspective view of the shoe of FIG. 1 seen from the back.

FIG. 4 is a view of the sole of the shoe of FIG. 1.

FIG. 5 is a right-side view of the shoe of FIG. 1 glued onto the hoof model.

FIG. 6 illustrates the flip-flop configuration and the resulting complete freedom of movement of the back portion of the shoe of FIG. 1 in relation to the hoof.

FIG. 7 is an alternative shoe with an opening in the sole.

### DESCRIPTION OF THE PREFERRED EMBODIMENT

As used herein in relation to bonding material being placed substantially only between the upper of the shoe and the hoof of the horse for adhering the shoe to the hoof of the horse, the term “substantially” is intended to mean that any bonding material than may end up on the sole was so placed or spread to the sole only unintentionally during the process of installing the shoe. Similarly, when the shoe is described and claimed as having a sole “substantially” unattached to the hoof and free to move in flip-flop fashion in relation to the hoof, the term is intended to mean that any attachment of the hoof to the sole is the result of such bonding material placed or spread unintentionally on the sole during the process of installing the shoe. The term “midsection” of the hoof, and correspondingly of the sole of the shoe, is intended to mean the transverse line along the longitudinal direction of the hoof and sole where they have their maximum width, the front and rear sections of the hoof and sole being the portions of the hoof and sole in front of and behind that line, respectively. By contrast, the “rear portion of the sole” is intended to refer to the area beyond the middle of the sole's longitudinal dimension (i.e., the middle of its length) as measured along the lower surface of the sole. Finally, as normally used generically in relation to footwear, the term “flip-flop” is intended to mean that at least the back portion of the sole of a shoe is not directly attached to and is able to move in relation to the foot of the wearer. The above definitions are all intended to apply to the description of the invention as well as to the claims that follow.

Always, in the art, the solution to the problem of separation of glued-on boots and shoes has been believed to be a better bond with the hoof. Since the separation occurs almost always at the heel because of the motion of the heel in relation to the horse boot or shoe, the logical and rational approach has been to strengthen the bond by using a larger area of adhesion and/or a stronger glue, especially at the heel. The present invention, on the contrary, is based on the totally unexpected discovery that the best solution lies instead in not bonding the shoe at all at the heel of the hoof and in leaving the entire back portion of the hoof free to move in flip-flop fashion, preferably by eliminating all bonding material between the bottom of the hoof and the sole of the shoe.

In essence, the idea amounts to a flip-flop design with a conventional upper that extends backward only roughly to the widest point of the hoof (and correspondingly the widest point of the shoe). The widest point of the hoof has the least amount of movement in both the vertical and horizontal planes. Because of this lack of movement, the bonds between the shoe and the hoof hold much tighter and are much less likely to fail from this region forward than at the heel. As a result, it is surprisingly more durable than shoes bonded at the heel and along the entire sides of the hoof. The absence of an upper in the rear portion of the shoe ensures that the heel and the entire back portion of the shoe are not connected to the hoof. As a result, the heel is allowed greater movement in all directions, which, in addition to improving the durability of the bond between the upper and the front portion of the hoof, also allows more movement of the hoof which in the long run results in a healthier hoof.

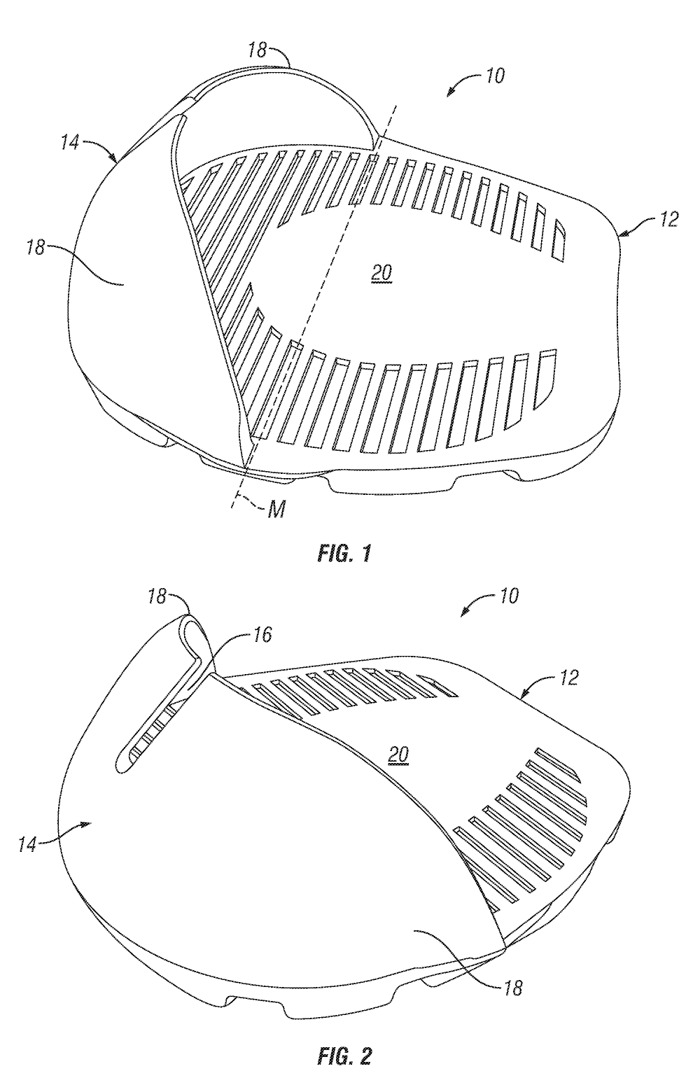

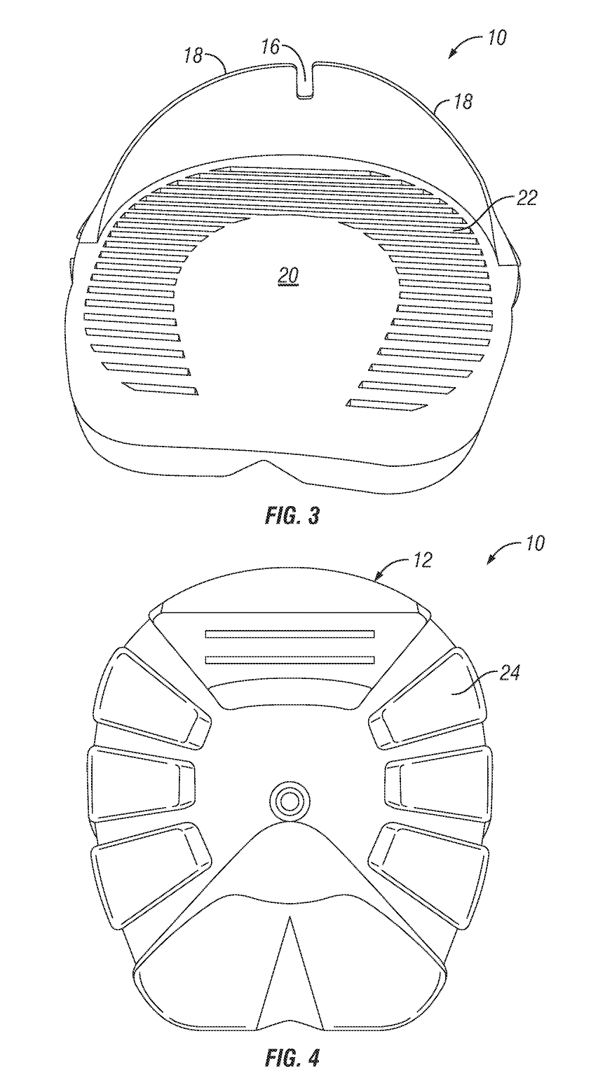

Referring to all figures, FIGS. 1-4 illustrate one embodiment of horse shoe 10 according to the invention. The shoe consists of a sole 12 and an upper 14 connected to the anterior edge to the periphery of the sole 12. The front portion of the upper 14 projects upward and rearward from the front edge of the sole 12 at an angle designed to conform approximately to the slope of a typical hoof, which is in the 50-70 degree range. As seen particularly in FIGS. 2 and 3, the preferred embodiment of the invention features a continuous upper 14 connected to the entire front portion of the sole 12 and including a front slit 16 defining right and left side walls 18. According to the invention, the side walls 18 are preferably limited to the front portion of the shoe so as not to protrude beyond the midsection of the hoof wearing the shoe, with their top edges sloping down toward the back to meet the sole 12 at about its widest point, which is also designed to correspond to the midsection of the hoof wearing the shoe and is typically within an inch forward of the center of the longitudinal dimension of the hoof (and correspondingly also of the center of the longitudinal dimension of the sole 12, as illustrated by the line M in FIG. 1). If the side walls 18 extend further backward, the advantages of the invention may still be obtained so long as the shoe is installed as detailed below.

The slit 16 allows the side walls 18 to resiliently fold in and out as necessary to conform to the shape of the hoof wearing the boot. To that end, the side walls 18 are also formed so as to be normally folded inward to a degree sufficient to press against the hoof of the horse when the boot is installed. The upper is made of a resilient material, such as polyurethane, so that the side walls 18 can bend easily to conform to the hoof, and also so that the rear opening defined by the side walls can be expanded to permit insertion of the hoof into the boot 10. The upper 14 and the sole 12 are preferably molded as a single unitary structure of polyurethane.

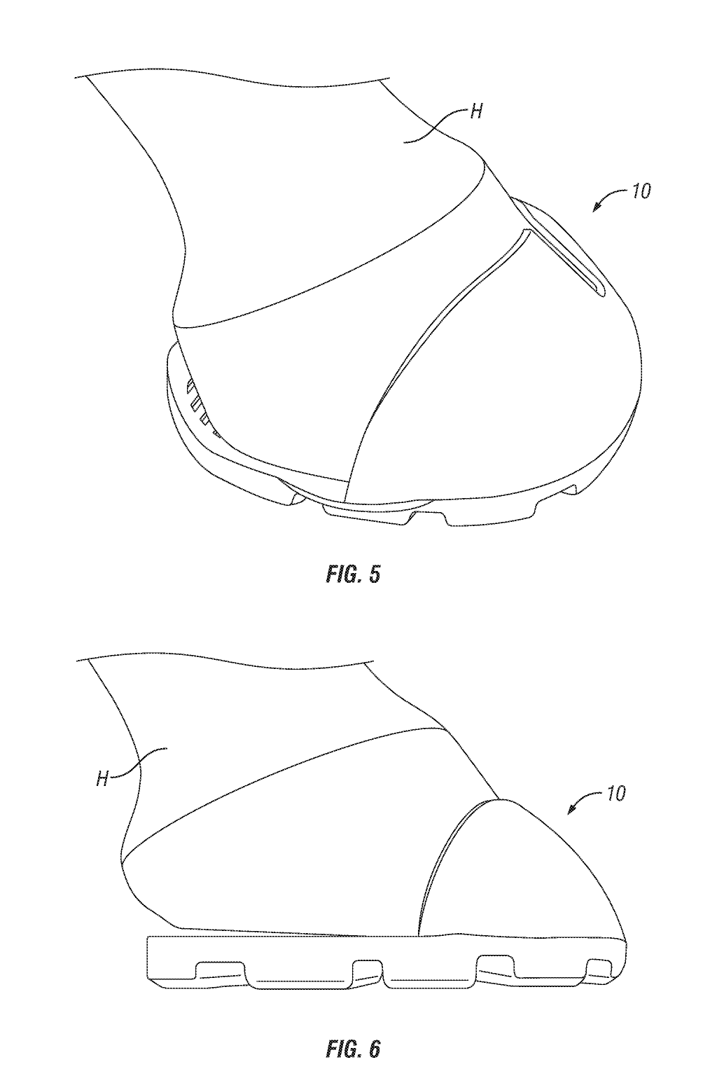

The sole 12 is preferably without any openings and, as seen particularly in FIG. 3, the top surface 20 of the sole 12 includes recesses 22 that have been found to facilitate the proper fitting of the shoe during installation, as detailed below. Alternatively, the surface 20 may be completely smooth, without any recesses 22 or other indentations. The bottom surface of the sole 12 features conventional treads 24, as seen in FIG. 4.

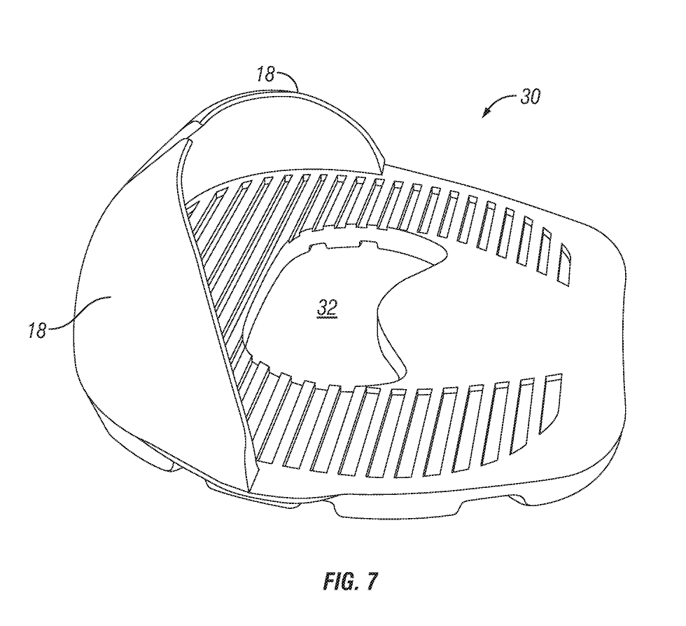

In use, the shoe 12 is installed using only glue to secure it to the hoof. According to the preferred embodiment of the invention, after placing an appropriate amount of bonding material only on the interior surface of the upper, and possibly also on the corresponding portions of the hoof's wall, the shoe is slipped under the hoof from the front until the front of the upper butts against the front portion of the hoof, as illustrated in FIG. 5 with a hoof model H. The boot is then kept firmly in place for the time required for the bonding material to set. The recesses 22 in the sole, if present, have been found to minimize any small sliding of the sole in relation to the hoof that could weaken the bond between the upper and the hoof if such motion were propagated to the adhesive material during the brief period while it is curing. Critically according to the invention, and contrary to all prior-art teachings, the glue is not applied at all at the heel or in any rear portion of the sole beyond the middle of its longitudinal dimension (i.e., its length, as measured along the lower surface of the sole). Very much preferably, no glue is applied anywhere on the sole, but only between the upper and the front portion of the hoof. As a result, as shown in FIG. 6, the half back portion of the shoe remains totally free of movement in relation to the hoof and the sole is connected only indirectly through the upper bonded to the front section of the hoof. The result is a flip-flop configuration that affords complete freedom of movement to the heel. Very surprisingly, this configuration also results in a more durable bond between the glued-on shoe and the hoof, which can be explained only by the fact that the movement of the freer heel during use does not tend to pull the heel away from the shoe and to cause the initial tear to propagate forward until the shoe ultimately separates completely, as experienced with previous glued-on boot and shoe configurations.

The glue is of the type currently used in the art of glued-on boots and shoes, preferably polyurethane glues, such as the product marketed under the mark Adhere by the Vettec Company of Oxnard, Calif., that cures in less than 30 seconds. Therefore, the shoe need not be held in place long before it is firmly attached to the hoof. The entire fitting process may be accomplished comfortably in less than two minutes.

FIG. 7 illustrates an alternative shoe embodiment 30 where the sole of the shoe features an opening 32 in the front portion of the sole. As explained in Ser. No. 14/184,675, this is done to promote the natural function of the frog in applications where it may be particularly desirable.

The shoe of the invention, with no glue between the sole and the hoof, has been tested with remarkable results when compared to glued-on shoes with an upper that extends toward the back of the hoof. It is not know exactly where the threshold is behind the widest portion of the hoof for the advantages of the invention to be maintained, but tests are underway to establish a reasonable measure of related performance. Based on current knowledge, it seems as though the advantages of the invention become measurably diminished when the upper is extended within a short distance backward from the widest point on the hoof.

While the invention has been shown and described herein with reference to what are believed to be the most practical embodiments, it is recognized that departures can be made within the scope of the invention. Therefore, the invention is not to be limited to the details disclosed herein but is to be accorded the full scope of equivalent articles.

1. A glued-on horse shoe on a horse's hoof, comprising:
a sole;
an upper attached to an outer periphery of the sole, said upper including side walls extending backward from a front side of the hoof and folded inward to butt against the hoof; and
bonding material placed between the hoof of the horse and interior surfaces of the upper for adhering the shoe to the hoof of the horse, said sole being unattached to a bottom surface of the hoof at a heel of the hoof and free to move in flip-flop fashion in relation to the hoof.

2. The horse shoe of claim 1, wherein the bonding material is placed substantially only between the upper of the shoe and the hoof of the horse, no glue being placed between the hoof and the sole of the shoe.

3. The horse shoe of claim 1, wherein the upper includes a front slit separating said side walls.

4. The horse shoe of claim 1, wherein said side walls extend backward only to a midsection of the hoof where the hoof has a widest point.

5. The horse shoe of claim 1, wherein the sole includes an opening.

6. The horse shoe of claim 1, wherein the shoe is made of molded unitary construction.

7. The horse shoe of claim 1, wherein the shoe is made of polyurethane

8. The horse shoe of claim 1, wherein the bonding material is placed substantially only between the upper of the shoe and the hoof of the horse, no glue being placed between the hoof and the sole of the shoe; the upper includes a front slit separating said side walls; the side walls extend backward only toward a midsection of the hoof where the hoof has a widest point; and the shoe is made of molded polyurethane unitary construction.

9. The horse shoe of claim 8, wherein the sole includes an opening.

10. A method of installing a glued-on horse shoe on a horse's hoof, comprising the following steps:
providing a horse shoe that includes a sole and an upper attached to an outer periphery of the sole, wherein the upper includes side walls extending backward from a front side of the shoe and folded inward to butt against a hoof of a horse wearing the shoe; and
placing bonding material between the hoof of the horse and interior surfaces of the upper for adhering the shoe to the hoof of the horse, said sole being unattached to a bottom surface of the hoof at a heel of the hoof and free to move in flip-flop fashion in relation to the hoof.

11. The method of claim 10, wherein the bonding material is placed substantially only between the upper of the shoe and the hoof of the horse, no glue being placed between the hoof and the sole of the shoe.

12. The method of claim 10, wherein the upper includes a front slit separating said side walls.

13. The method of claim 10, wherein said side walls extend backward only to a midsection of the hoof where the hoof has a widest point.

14. The method of claim 10, wherein the sole includes an opening.

15. The method of claim 10, wherein the shoe is made of molded unitary construction.

16. The method of claim 10, wherein the shoe is made of polyurethane

17. The method of claim 10, wherein the bonding material is placed substantially only between the upper of the shoe and the hoof of the horse, no glue being placed between the hoof and the sole of the shoe; the upper includes a front slit separating said side walls; the side walls extend backward only toward a midsection of the hoof where the hoof has a widest point; and the shoe is made of molded polyurethane unitary construction.

18. The method of claim 17, wherein the sole includes an opening.
